(19) United States
(12) Patent Application Publication
(10) Pub. No.: US 2015/0027628 A1
(43) Pub. Date: Jan. 29, 2015

(54) METHOD OF ENCAPSULATING A PROJECTION AND MAKING AN EVACUATED CABINET

(71) Applicant: WHIRLPOOL CORPORATION, Benton Harbor, MI (US)

(72) Inventors: CHARLES R. CRAVENS, SAINT JOSEPH, MI (US); CHRISTIAN GIANNI, STEVENSVILLE, MI (US); JAMES C.L. GUARINO, KALAMAZOO, MI (US); STEVEN J. KUEHL, STEVENSVILLE, MI (US); JOHN E. MEDDLES, MARION, OH (US); GUOLIAN WU, SAINT JOSEPH, MI (US)

(73) Assignee: WHIRLPOOL CORPORATION, Benton Harbor, MI (US)

(21) Appl. No.: 14/197,555

(22) Filed: Mar. 5, 2014

Related U.S. Application Data
(60) Provisional application No. 61/774,625, filed on Mar. 8, 2013.
(60) Provisional application No. 61/774,630, filed on Mar. 8, 2013.

(51) Int. Cl. B29C 65/14; B29C 65/44

(52) U.S. Cl. CPC B29C 65/14; B29C 65/44; B29K 2105/253
USPC 156/275.1

(57) ABSTRACT

The invention relates to a method of using high velocity metal forming to encapsulate a projection of a non-metallic article by a metallic article and a method of crimping terminal flanges defining an interstitial space therebetween, while trapping a vapor barrier element between the terminal flanges, thereby hermetically sealing the interstitial space.

### CROSS-REFERENCE TO RELATED APPLICATIONS

The present application claims the benefit of U.S. Provisional Patent Application No. 61/774,625, filed Mar. 8, 2013, and U.S. Provisional Patent Application No. 61/774,630, filed Mar. 8, 2013, which are incorporated by reference herein in their entirety.

### BACKGROUND OF THE INVENTION

Encapsulation of a projection may be used for a variety of purposes. In cases where the projection is a peripheral edge of a planar element, such as refrigerator shelves, cooktops, washer lids, and the like, the encapsulation may provide protection to the peripheral edge and/or may provide a mounting structure. The use of adhesives may increase fabrication time and expenses, limit the working life of the non-metallic component, contribute to a detrimental appearance from improper alignment of components, and increase waste.

Evacuated structures are often used in environments where it is desirable to thermally insulate the interior of the structure from the surrounding environment. An illustrative example is a refrigerator/freezer cabinet, which may be fabricated by coupling an inner metallic tub to an outer metallic tub, with insulation material between the tubs. In some methods, the tubs are welded together, which may provide a thermal path negatively impacting the insulating qualities of the cabinet. In other methods, such as when a metallic outer tub is coupled to a metallic inner tub, a polymer profile adhesively bonded into place between the outer metallic tub and an inner metallic tub has been utilized in place of a weld. However, the integrity of an adhesive is not adequately predictable.

### BRIEF DESCRIPTION OF THE INVENTION

In one aspect, the invention relates to a method of encapsulating a projection of a non-metallic article by a metallic article by arranging the non-metallic article and metallic article to locate the projection within a corresponding recess in the metallic article. The projection may be encapsulated by the metallic article by applying a pressure wave or electromagnetic field to conform the metallic article about the projection. The metallic article may extend between first and second surfaces of the non-metallic article, and may overlie each of the first and second surfaces.

In another aspect, the invention relates to a method of making an evacuated structure. An evacuated structure may have first and second metallic elements, each of which may terminate in a terminal flange. The structure may be manufactured by positioning the first and second metallic elements relative to each other to define an interstitial space between the metallic elements. A vapor barrier element may be placed between the terminal flanges. A first one of the terminal flanges may be moved at a speed great enough to plastically flow about a second one of the terminal flanges to crimp together the terminal flanges and trap the vapor barrier element between the terminal flanges, thereby hermetically sealing the interstitial space. Gas may be evacuated from the interstitial space.

### BRIEF DESCRIPTION OF THE DRAWINGS

In the drawings:

FIG. 1 is a schematic representation of a planar right-angled non-metallic article, and a right-angled metallic article adapted for encapsulating a perimeter projection of the non-metallic article, according to an exemplary embodiment of the invention.

FIG. 2 is an exploded perspective view of the non-metallic article and metallic article illustrated in FIG. 1.

FIG. 3 is a schematic plan view representation of the non-metallic article and metallic article illustrated in FIG. 1 during encapsulation by the metallic article of the non-metallic article.

FIG. 4A is a sectional elevation view of an exemplary embodiment of the encapsulation process illustrated in FIG. 3 showing an alignment of the non-metallic article and a first embodiment metallic article.

FIG. 4B is a sectional elevation view of the non-metallic article and metallic article at the completion of encapsulation illustrated in FIG. 4A.

FIG. 5A is a sectional elevation view of the exemplary embodiment of the encapsulation process illustrated in FIG. 3 showing an alignment of the non-metallic article and a second embodiment metallic article.

FIG. 5B is a sectional elevation view of the non-metallic article and metallic article at the completion of encapsulation illustrated in FIG. 5A.

FIG. 6A is a sectional elevation view of the exemplary embodiment of the encapsulation process illustrated in FIG. 3 showing an alignment of the non-metallic article and a third embodiment metallic article.

FIG. 6B is a sectional elevation view of the non-metallic article and metallic article at the completion of encapsulation illustrated in FIG. 6A.

FIG. 7A is a sectional elevation view of the exemplary embodiment of the encapsulation process illustrated in FIG. 3 showing an alignment of the non-metallic article and a fourth embodiment metallic article.

FIG. 7B is a sectional elevation view of the non-metallic article and metallic article at the completion of encapsulation illustrated in FIG. 7A.

FIG. 8 is a perspective view of an oven having an exemplary encapsulated glass cooktop and windowed oven door according to the invention.

FIG. 9 is a perspective view of a refrigerator having exemplary encapsulated glass shelves according to the invention.

FIG. 10 is a perspective view of a cabinet, without a closing door, comprising an inner metallic tub hermetically sealed to an outer metallic tub according to an exemplary embodiment of the invention.

FIG. 11A is an enlarged perspective view of a section of the cabinet of FIG. 10 illustrating details of the hermetic seal coupling the inner metallic tub to the outer metallic tub, with an optional door seal.

FIGS. 11B-11D are enlarged sectional views of an inner and outer metallic tub assembly undergoing a process of fabricating an alternate embodiment of a hermetic seal.

FIGS. 12A and 12B are sectional views of an inner and outer metallic tub assembly undergoing hermetic sealing.

FIG. 13 is a schematic plan view of an outer metallic tub and metal forming apparatus for introducing squared corners in the outer metallic tub.

FIG. 14 is a schematic plan view of a cabinet manufactured according to an embodiment of the invention illustrating an alignment of a high-velocity metal forming generator relative to the cabinet.

FIGS. 15A-15F are schematic elevation views of different cabinet configurations manufactured utilizing variations of the process according to the invention.

FIG. 16 is a perspective elevation view of a front portion of an exemplary refrigerator including the door seal coupled with the refrigerator cabinet as illustrated in FIG. 11A.

FIGS. 17A and B are vertical sectional views of a manufacture of an exemplary schematic inner tub and outer metallic tub having a hermetic seal including a distinct frame coupled with the inner tub and the outer metallic tub according to another embodiment of the invention.

FIG. 18 is a vertical sectional view of an exemplary schematic inner tub and outer metallic tub having a hermetic seal including an alternate distinct frame coupled with the inner tub and the outer metallic tub according to another embodiment of the invention.

FIG. 19 is an exemplary schematic inner tub nested within an outer tub, and a distinct unitary frame, in a perspective view from above, illustrating a step in the process of coupling the frame, inner tub, and outer tub to form a hermetic seal.

### DETAILED DESCRIPTION OF EMBODIMENTS OF THE INVENTION

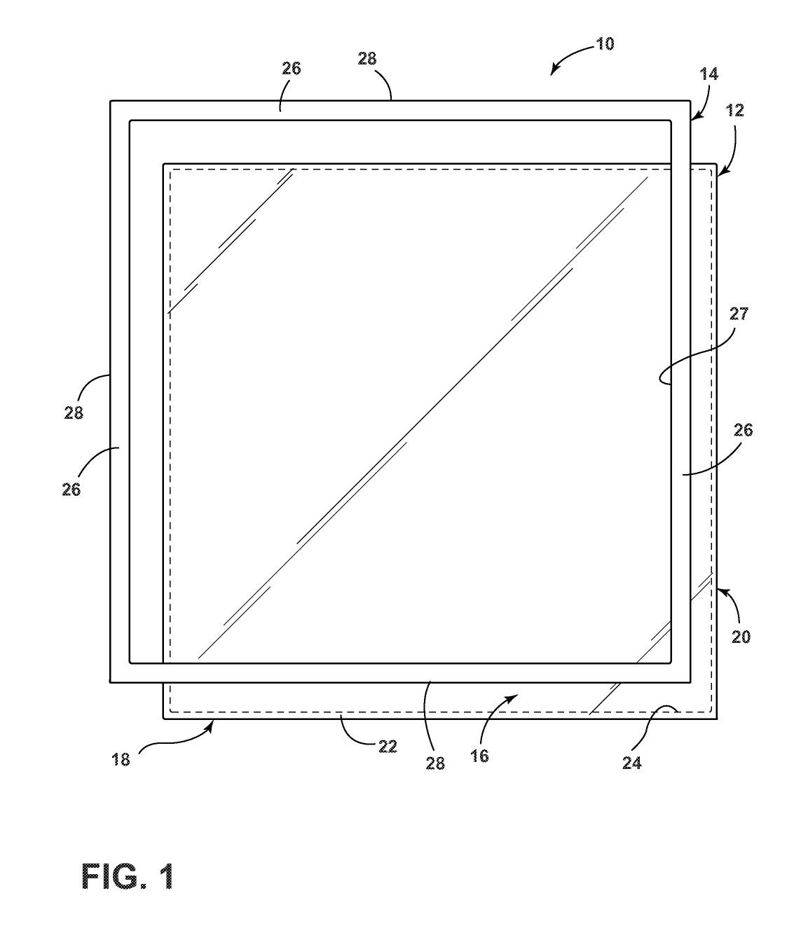

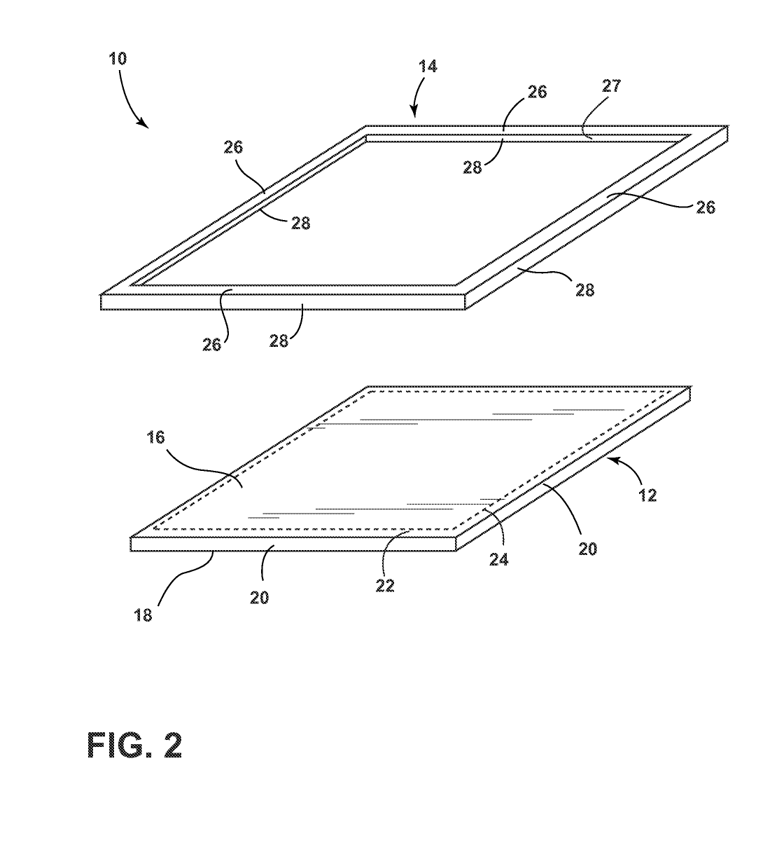

Referring to the Figures, and particularly to FIGS. 1 and 2, a schematic representation of an encapsulation assembly 10 according to an exemplary embodiment of the invention is illustrated. The assembly 10 may comprise a non-metallic article 12 encapsulated about its perimeter by a metallic article 14. The non-metallic article 12 may comprise a material that is generally unaffected by electromagnetic forces, such as glass, a polymer, a ceramic, and the like. The non-metallic article 12 is described herein as an exemplary planar shelf or cooktop, although the non-metallic article 12 may have other selected configurations. The metallic article 14 may comprise a metal that is responsive to electromagnetic forces, such as steel, stainless steel, aluminum, copper, alloys thereof, and the like.

The non-metallic article 12 is illustrated as an exemplary square plate-like body having a first surface 16 in opposed parallel disposition with a second surface 18. A peripheral edge 20 may define the edges of the non-metallic article 12. A projection 22 may be defined by a portion of the non-metallic article 12 extending between the peripheral edge 20 and a projection border 24. The projection border 24 may be defined by a line located somewhat away from and parallel to the peripheral edge 20.

The metallic article 14 is illustrated as a generally open frame-like body adapted for enclosing the non-metallic article 12 along the projection 22. Each side of the metallic article 14 may be L-shaped, having a finish flange 26 adapted for contact with either the first surface 16 or second surface 18 and terminating in an inner edge 27, and a high-velocity metal forming (HVMF) flange 28 adapted for extension along the peripheral edge 20. The inner edge 27 of the finish flange 26 may coincide with the projection border 24.

High-velocity metal forming moves the metal at a speed such that the metal plastically flows. For most metals, speeds greater than about 100 meters/second (m/s) will result in plastic flowing of the metal. These speeds are about at least 100 times faster than traditional stamping/press break methods, which are about 1 m/s. Energy for forming the metal can be provided by an electromagnetic force field or high-pressure waves. Electromagnetic energy may be utilized to reshape portions of a metal workpiece without the need for molds, anvils, and the like. A high-intensity electromagnetic force field is generated, and the metal workpiece is selectively introduced into the force field, which bends or folds the workpiece in a preselected manner to shape the workpiece into a finished product. The effect of the force field is to move a portion of the metallic article 14 at a high velocity, which can be accompanied by a plastic flow of the metallic article 14 about the non-metallic article 12. This process is utilized as described herein to encapsulate a portion of the non-metallic article 12 by bending the metallic article 14 about the portion to be encapsulated.

Alternatively, high-pressure waves can be generated, with the waves directed toward selected areas of the workpiece. The high-pressure waves impact the selected areas and bend the workpiece, or drive the workpiece into a mold. The high-pressure waves can be generated by triggering a controlled explosion in a suitable chamber adapted for directing the pressure waves against the workpiece. Alternatively, the high-pressure waves can be generated by an instantaneous release of high-intensity electromagnetic energy to create a high-intensity electromagnetic force field. Such a force field can be developed by the controlled release of electric current from a bank of capacitors.

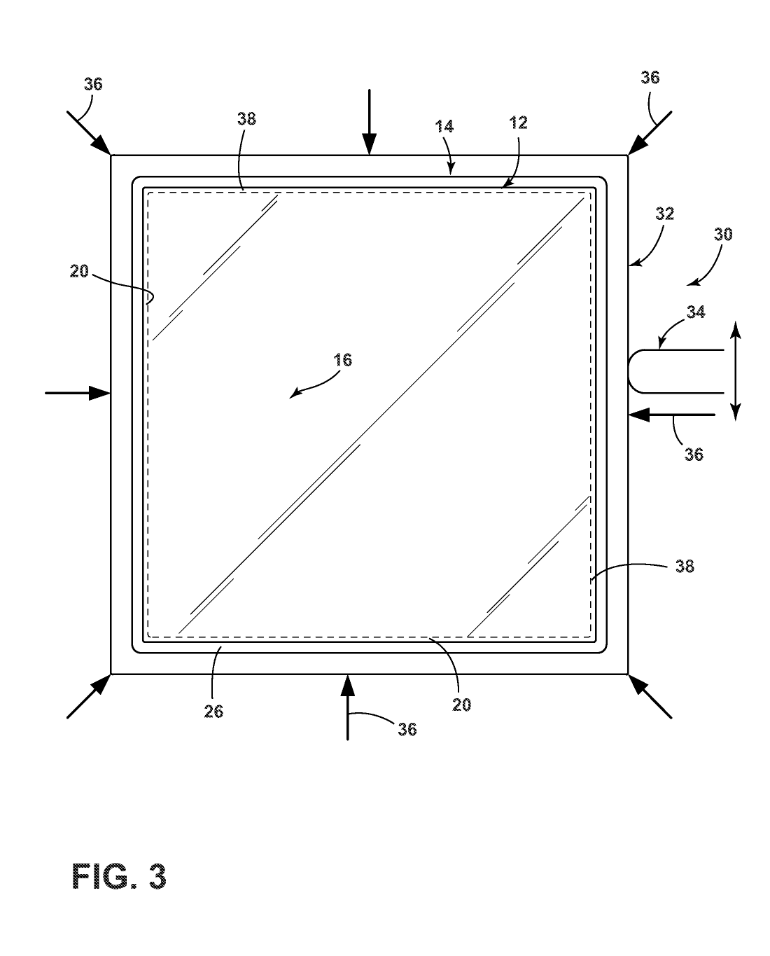

FIG. 3 illustrates a general embodiment of an encapsulation process 30. The process 30 may be conducted on a non-metallic article 12, and a metallic article 14. An electromagnetic coil 34 may be oriented relative to the metallic article 14 for bending the metallic article 14. A support article 32 may provide a means of supporting the non-metallic article 12 and metallic article 14 in a selected fixed configuration during the encapsulation process. The electromagnetic coil 34 may be integrated with the support article 32 as part of a mobile EMF assembly. For example, the electromagnetic coil 34 may travel along a path defined by the support article 32 during the encapsulation process. As illustrated in FIG. 3, the coil 34 may move in a controlled manner along the metallic article 14, traversing the perimeter of the metallic article 14.

The electromagnetic coil 34 may be configured in a known manner for generating electromotive force, as represented in FIG. 3 by electromotive force vectors 36. The electromotive force vectors 36 may impart a force on the metallic article 14, specifically the flange 28, so that portions of the metallic article 14 plastically flow to encapsulate the projection 22. The metallic article 14 may encapsulate the non-metallic article 12 with a relatively narrow gap 38 separating the peripheral edge 20 from the metallic article 14. Thus, for example, the finish flange 26 may overlie the first surface 16 along the projection 22, and the flange 28 may overlie the second surface 18 along the projection 22.

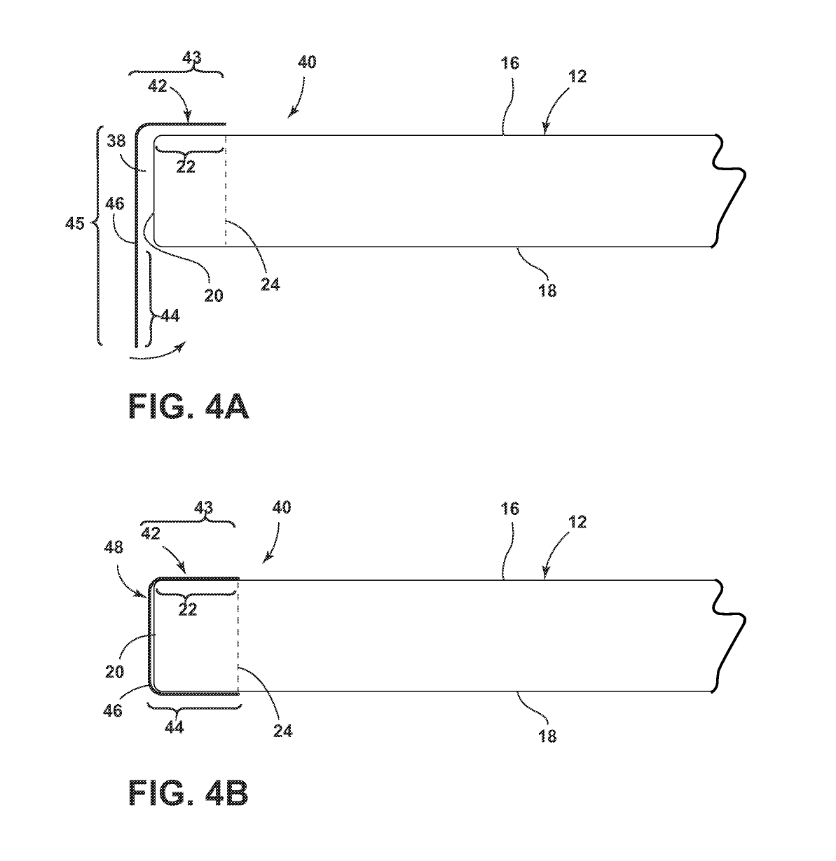

FIGS. 4A and 4B illustrate an encapsulation process 40. A metallic article 42 is a generally L-shaped member having a first leg 43, and a second leg 45 generally orthogonal to the first leg 43. The first leg 43 may be disposed along the first surface 16, and the second leg 45 may be disposed along the peripheral edge 20. The second leg 45 may be somewhat longer than the first leg 43 to enable the second leg 45 to be bent into disposition along the second surface 18. The second leg 45 may be bent along a bend line 46 to define a flange 44 extending along the surface 18. The flange 44 may be bent by the EMF generated by the electromagnetic coil 34 acting on the flange 44. As a result, for example, the first leg 43 may overlie the first surface 16 along the projection 22, and the flange 44 may overlie the second surface 18 along the projection 22.

As illustrated in FIG. 4B, bending of the flange 44 into position along the surface 18 may result in the creation of an encapsulation recess 48 having a pair of parallel spaced legs 43, 45 joined orthogonally by a portion of the second leg 45. The gap 38 may separate the second leg 45 from the peripheral edge 20.

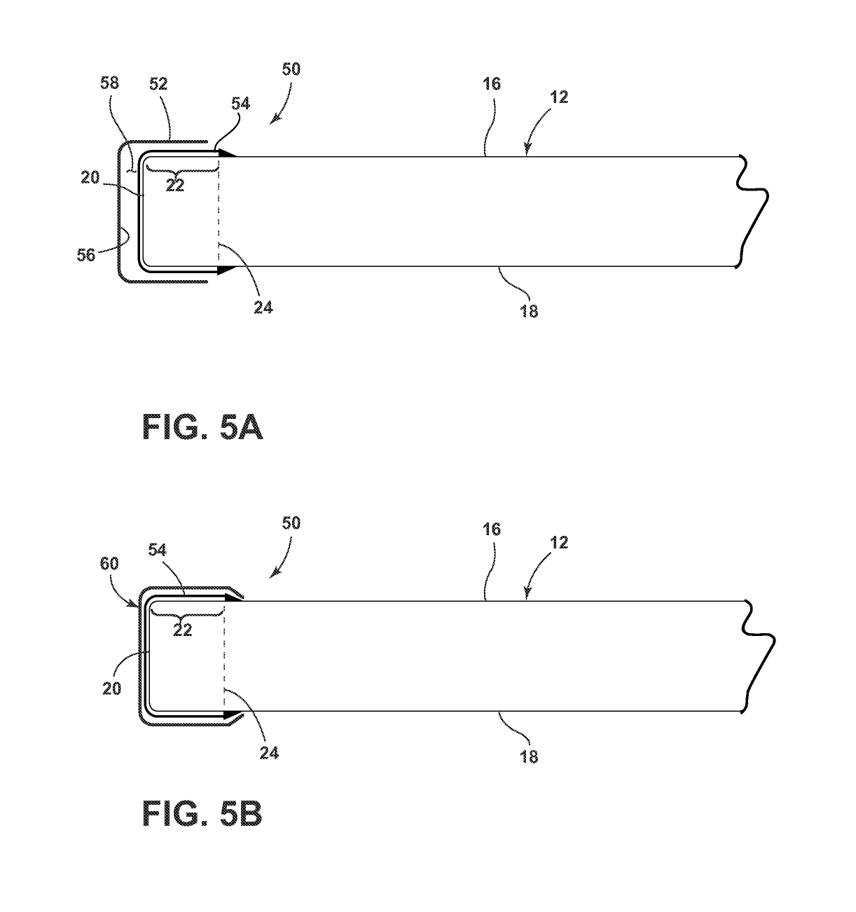

FIGS. 5A and 5B illustrate an alternate encapsulation process 50 that may be somewhat similar to the encapsulation process 40. The metallic article 52 may be a channel-shaped elongate member 60 adapted for encapsulation of the projection 22. The channel-shaped member 60 may define a recess 56 into which the projection 22 may be seated. A gap 58 may separate the member 60 and peripheral edge 20. The encapsulating process may draw the channel-shaped member 60 around the projection 22 so that one leg of the channel-shaped member 60 may overlie the first surface 16 along the projection 22, and the other leg of the channel-shaped member 60 may overlie the second surface 18 along the projection 22.

A buffer element 54 may be placed around the projection 22 between the surfaces 16, 18 and the metallic article 52. The buffer element 54 may be any material suitable for reducing the transfer of the force acting on the metallic article 52 to the non-metallic article 12. The material and physical characteristics, e.g. thickness, stiffness, resiliency, plasticity, proximity, location, forming the buffer element 54 may be selected to ensure that the force applied by the metallic article 52 onto the non-metallic article 12 is not aesthetically and/or physically damaging to the non-metallic article. As illustrated in FIG. 5B, the encapsulating process may draw the channel-shaped member 60 around the buffer element 54 and projection 22. Encapsulation may tightly retain the channel-shaped member 60 against the buffer element 54 and over the projection 22.

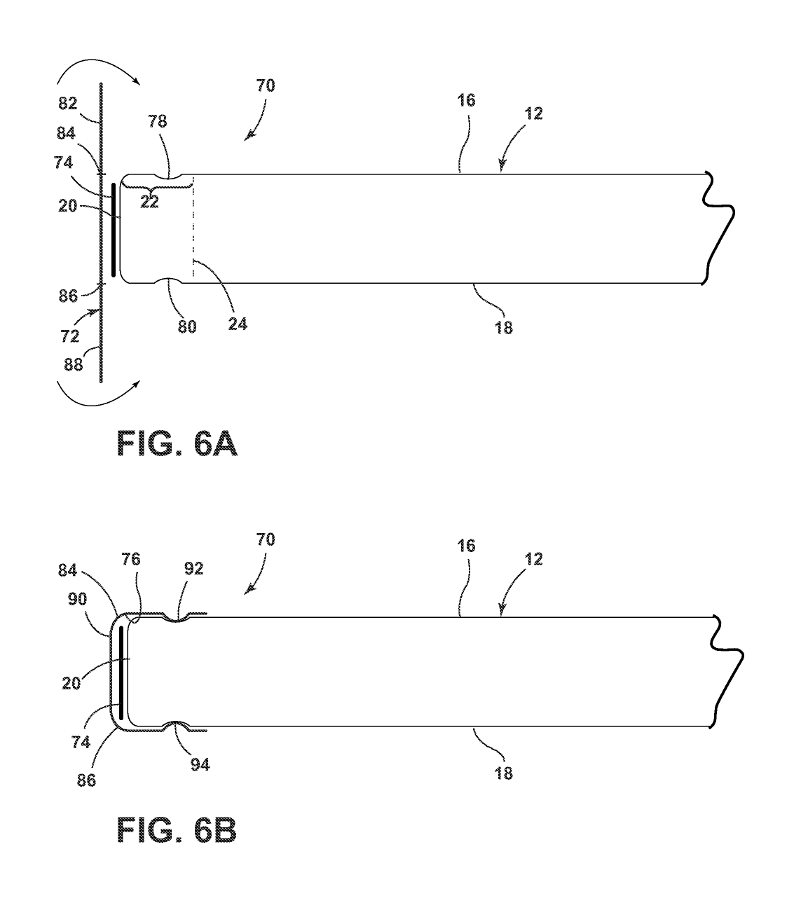

FIGS. 6A and 6B illustrate another encapsulation process 70 including wrapping of a metallic article 72 about the projection 22, with a buffer element 74 extending along the peripheral edge 20 between the peripheral edge 20 and the generally flat, ribbon-like metallic article 72. The non-metallic article 12 may be configured with first and second grooves 78, 80, respectively, extending along the projection 22 parallel with the peripheral edge 20.

The metallic article 72 may comprise a first flange 82 extending upwardly from a first bend line 84 and a second flange 88 extending downwardly from a second bend line 86. The bend lines 84, 86 may correspond with the orthogonal edges of the non-metallic article 12. The buffer element 74 and peripheral edge 20 may align with the portion intermediate the first and second bend lines 84, 86, respectively.

During the process, the flanges 82, 88 may be folded at the first and second bend lines 84, 86 to overlie the first and second surfaces 16, 18, respectively, along the projection 22. The folded flanges 82, 88 may define a recess 76 in the metallic article 72 for receipt of the projection 22 therein. The flanges 82, 88, may be drawn into the grooves 78, 80, to define a first linear dimple 92 and a second linear dimple 94 in the metallic article 72, coextensive with the grooves 78, 80, respectively.

The folding and dimpling may occur simultaneously or sequentially. The electromagnetic coil 34 may be moved along the centerline of the metallic article 72 and peripheral edge 20 to make one or both bends, followed by formation of the linear dimples. This may include sequentially reorienting the electromagnetic coil 34 adjacent the first surface 16 and second surface 18 along the flanges 82, 88. Alternatively, a coil may be built that can bracket and move along both sides of the projection 22 to concurrently form the dimples 92, 94.

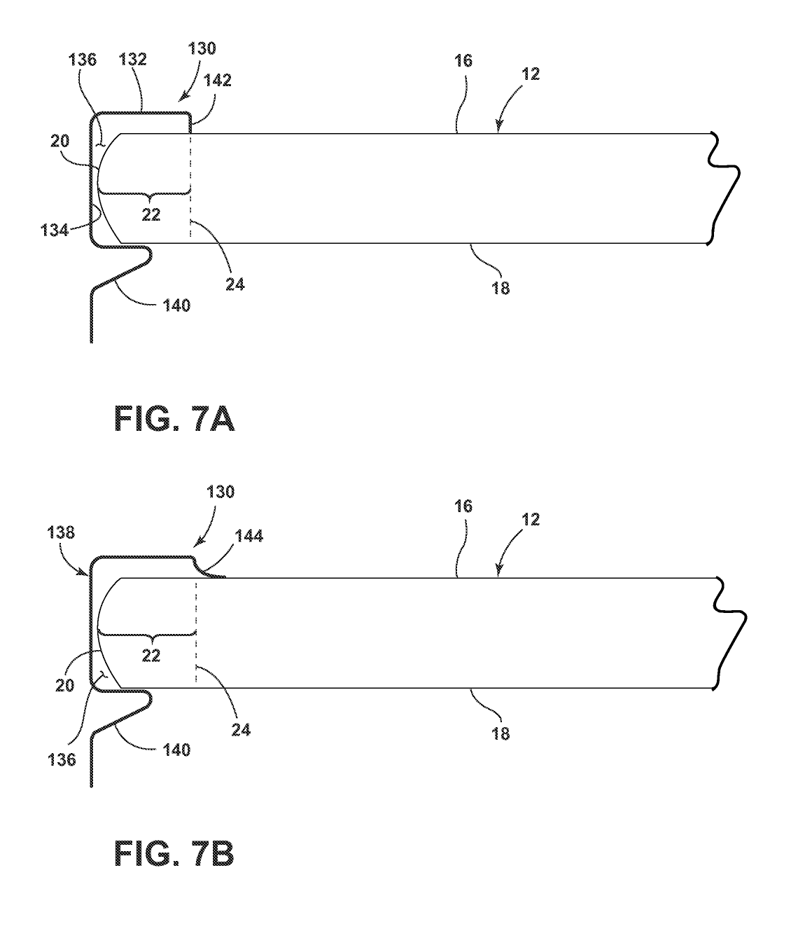

FIGS. 7A and 7B illustrate another encapsulation process 130 including wrapping of a metallic article 132, incorporating a non-metallic article support flange 140, about the projection 22. The metallic article 132 may comprise a metallic article flange 142 extending toward the first surface 16 to meet the projection border 24. The metallic article 132 may include a recess 134 into which the projection 22 may be seated. A gap 136 may separate the recess 134 from the peripheral edge 20, thereby enabling some movement of the non-metallic article 12 relative to the metallic article 132.

Referring to FIG. 7A, encapsulation of the non-metallic article 12 by the metallic article 132 may position the metallic article flange 142 in orthogonal contact with the first surface 16. A buffer element (not shown) may be utilized to protect the first surface 16 from the metallic article flange 142. The encapsulation process 130 may terminate at this point. Alternatively, as illustrated in FIG. 7B, encapsulation may be continued to produce a somewhat resilient non-metallic article retention clip 144 exerting a compressive force against the first surface 16. Introduction of a buffer element (not shown) between the retention clip 144 and the first surface 16 may provide a fluid-tight perimeter seal. With either embodiment, a portion of the metallic article 132 may overlie the first surface 16 along the projection 22, and the support flange 140 may overlie the second surface 18 along the projection 22.

While a buffer element 54, 74 is illustrated in the embodiments of FIGS. 5 and 6, it should be noted that a buffer element may be used with any of the embodiments. A buffer element may be used on any part of the interface between a non-metallic article and a metallic article.

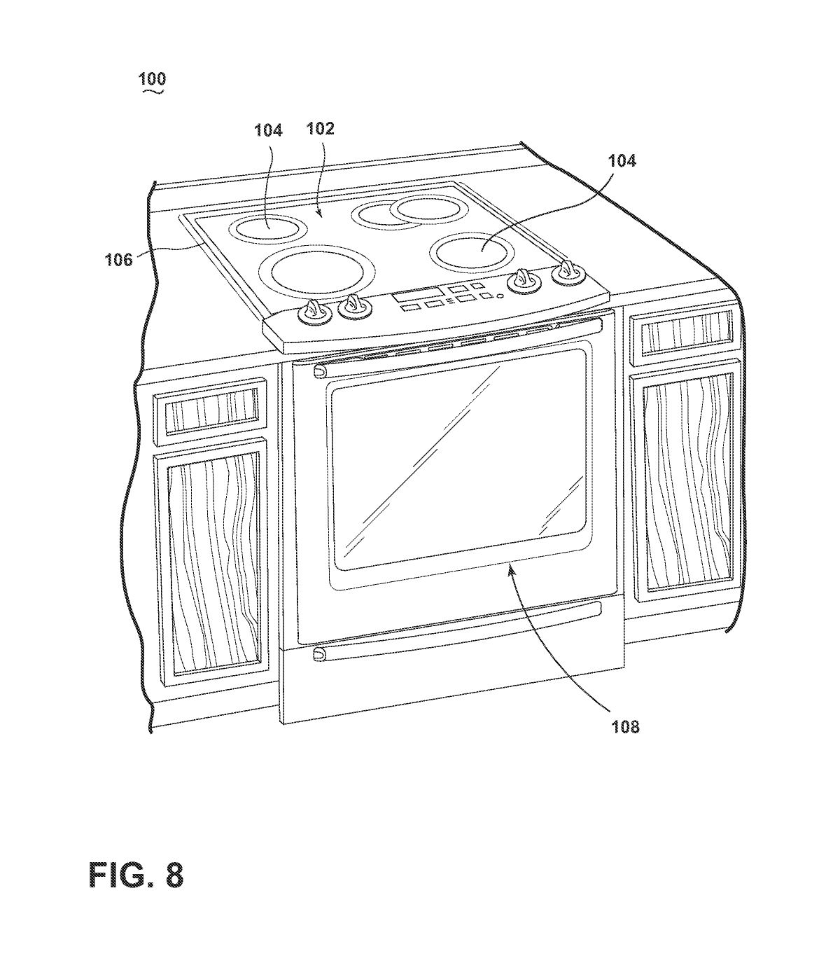

FIG. 8 illustrates a cooktop 100 fabricated according to the processes described herein, and comprising heating elements 104. A plate-like non-metallic article 102, which is illustrated as a type of glass, serving as the cooktop 100 may be encapsulated by a metallic encapsulating article 106 along the cooktop perimeter. The interior portion of the cooktop 100 may be uninterrupted, with the heating elements 104 beneath the cooktop 100.

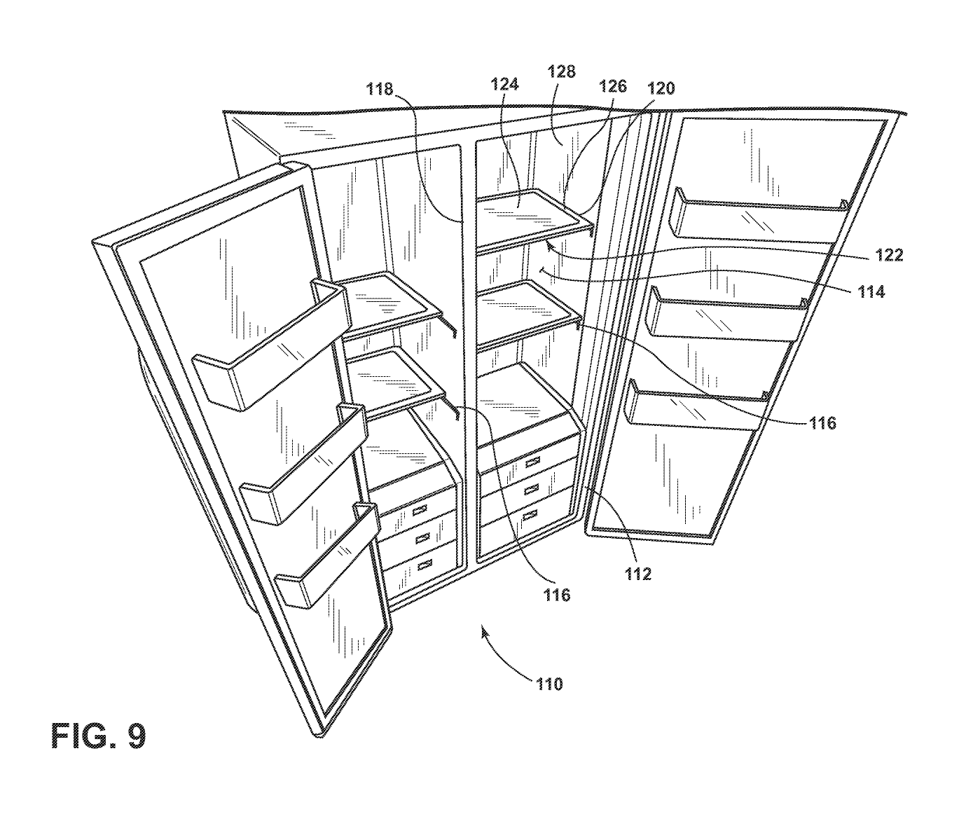

Alternatively, circular portions of the cooktop 100 associated with the heating elements 104 may be removed to expose the heating elements. The inside circumference of each circular portion may be encapsulated by a metallic article in a process similar to that described above. Furthermore, encapsulation may be completed on an oven door/window 108 assembly in a similar manner. Referring to FIG. 9, a refrigerator 110 may comprise a cabinet 112 defining an interior 114. The interior 114 may have shelf rails 116 attached to side walls 128 and a center wall 118. Each pair of opposed shelf rails 120 may support a shelf 122 comprising a non-metallic article 124 encapsulated along its perimeter within an encapsulating metal article 126, generally as previously described herein. The shelves 122 may be adapted for slidable movement out of and into the interior 114. The encapsulating metal article 126 may be configured with a short wall projecting upwardly around the perimeter of the shelf 122 to define a basin for holding spilled liquids.

This aspect of the invention has been described herein in the context of an exemplary refrigeration apparatus, and a cooktop/oven. However, the encapsulation methods described herein may also be utilized for a clothes washer or dryer door, which may include a transparent panel set into a metallic panel. The metallic component may include materials such as carbon steel, stainless steel, aluminum, copper, nickel, bronze, and alloys of these metals.

Stainless steel may be produced in ferritic and martensitic forms to enhance its electromagnetic properties, and facilitate forming with EMF.

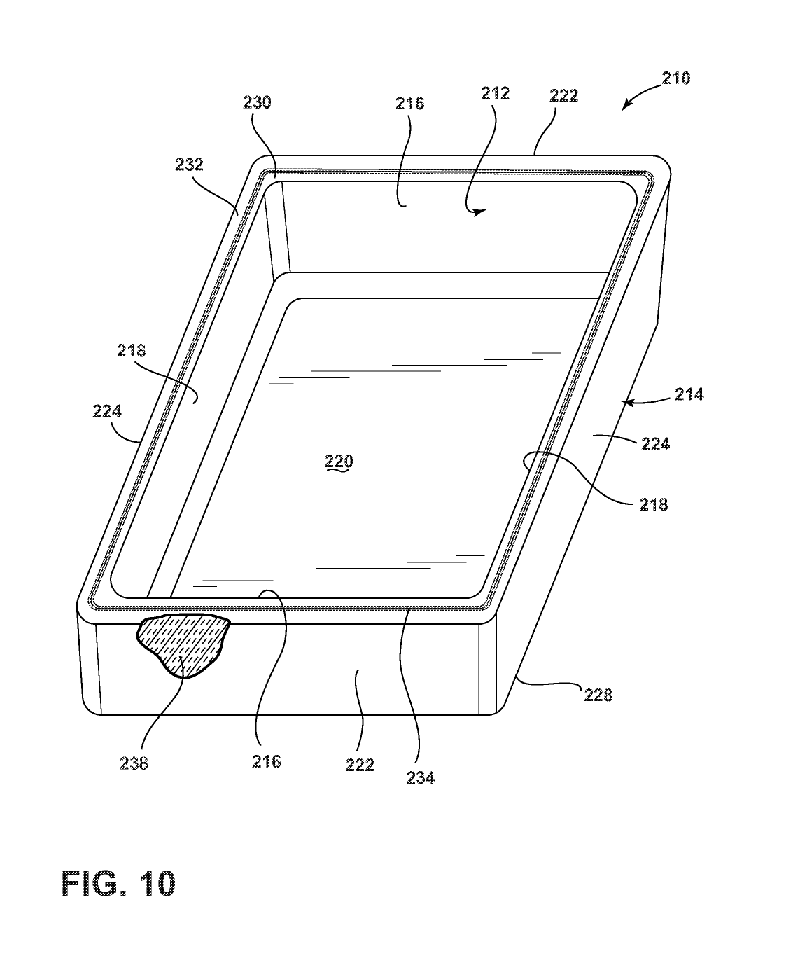

Referring now to FIG. 10, an exemplary evacuated structure 210, such as a vacuum insulated refrigerator cabinet shell, manufactured according to the invention is illustrated. The cabinet shell 210 may comprise an inner metallic tub 212 (also referred to as an inner liner) and an outer metallic tub 214 (also referred to as an outer wrapper). The inner metallic tub 212 and outer metallic tub 214 may be fabricated in a known manner, such as by draw forming, and may be configured so that the inner metallic tub 212 may nest within the outer metallic tub 214.

The inner metallic tub 212 and outer metallic tub 214 may be separately draw formed from pre-painted material, such as aluminum, cold-rolled steel, or stainless steel, and hermetically crimped together to form the shell 210, as hereinafter described.

The inner metallic tub 212 may include a pair of opposed inner liner end walls 216 transitioning to a pair of opposed inner liner sidewalls 218 to define a generally rectangular perimeter. Each of the end walls 216 and sidewalls 218 may transition to an inner liner back wall 220.

The outer metallic tub 214 may include a pair of opposed outer wrapper end walls 222 transitioning to a pair of opposed outer wrapper sidewalls 224 to define a generally rectangular perimeter. Each of the end walls 222 and sidewalls 224 may transition to an outer wrapper back wall 228.

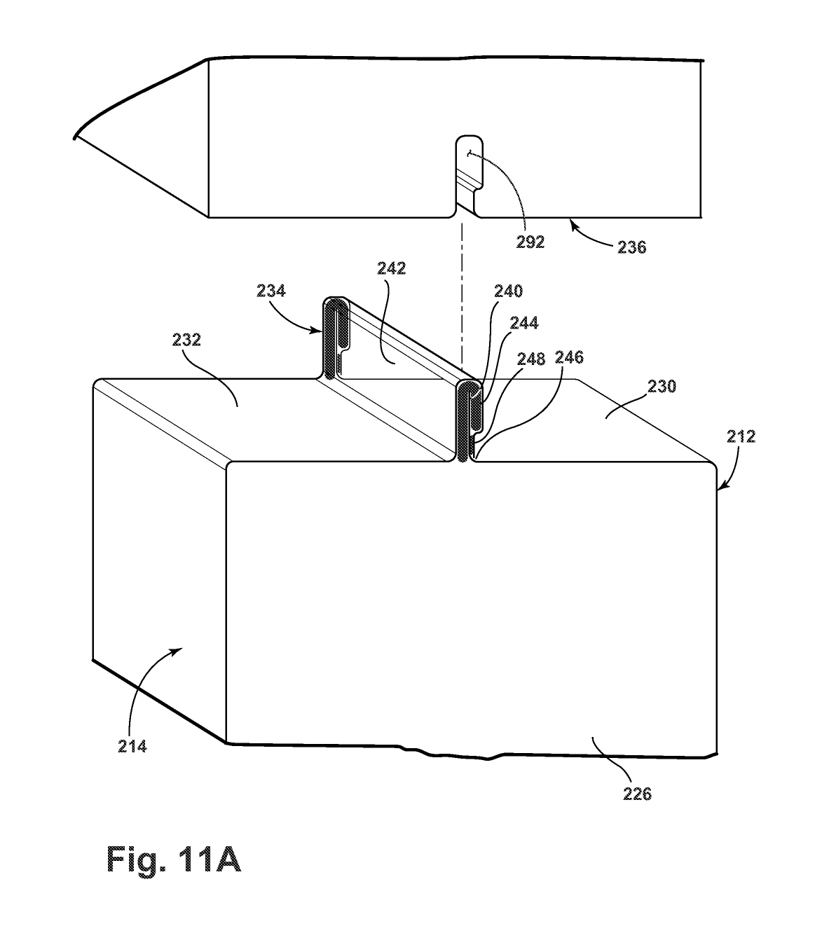

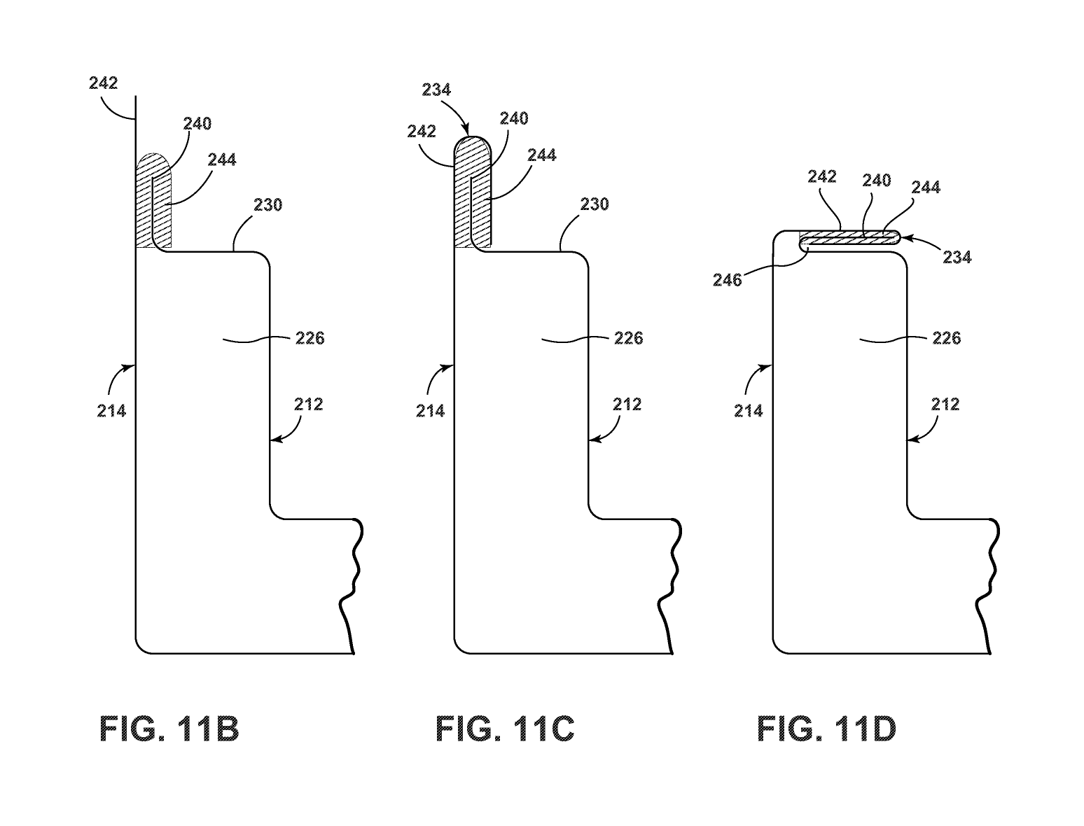

FIG. 11A illustrates the inner metallic tub 212, the outer metallic tub 214, and a crimped portion 234 including an interstitial insert, which is illustrated as a vapor barrier element 244. The inner metallic tub end walls 216 and inner metallic tub sidewalls 218 may transition to an inner metallic tub end plate 230. The outer metallic tub end walls 222 and outer metallic tub sidewalls 224 may transition to an outer metallic tub end plate 232. The inner metallic tub 212 may terminate in an inner metallic tub terminal flange 240 extending generally away from the inner metallic tub end plate 230. An outer metallic tub terminal flange 242 may extend away from the outer metallic tub end plate 232. The outer metallic tub terminal flange 242 may have a somewhat greater dimension orthogonal to the end plate 232 than the inner metallic tub terminal flange 240 to enable the outer metallic tub terminal flange 242 to fold over the inner metallic tub terminal flange 240.

In an alternate configuration, the outer metallic tub 214 may not include an outer metallic tub end plate 232 (FIGS. 11B-11D). With this configuration, the outer metallic tub terminal flange 242 may extend as a continuation of the outer metallic tub end walls 222 and outer metallic tub sidewalls 224.

In accordance with an exemplary embodiment of the invention, the inner metallic tub 212 may be nested within the outer metallic tub 214 to be coupled through the crimped portion 234. In such a configuration, the metallic tubs 212, 214 may define an interstitial space 226 therebetween. The interstitial space 226 may be filled with a compressed filler material 238, such as fumed silica or other suitable thermal insulating material, for purposes of insulating the cabinet shell 210.

The crimped portion 234 may be crimped with the interstitial insert 244 to provide a thermal break between the metallic tubs 212, 214, and a vacuum seal fluidly isolating the interstitial space 226 from the exterior of the vacuum insulated refrigerator cabinet shell 210. The vapor barrier element 244 may be an ethylene-vinyl alcohol (EVOH) copolymer or silica glass in a ribbon of suitable thickness so that a bend radius in the crimped portion 234 does not introduce cracks in paint or coatings applied to the metallic tubs 212, 214. A material having properties generally equivalent to those of the above materials, such as a low permeability to gases and particularly water vapor, pliability over a range of −40° C. to 65° C., and a low coefficient of thermal conductivity, may be utilized as the vapor barrier element 244. Examples of vapor barrier materials may include, but are not limited to, bi-oriented EVOH film, vacuum metallized EVOH film, polyethylene terephthalate (PET) with silicon oxide (SiOx) or aluminum oxide (AlOx) layers deposited on the PET, cellulose films prepared from aqueous alkali (NaOH or LiOH)/urea solutions, polyether amine polymers (e.g. epoxy-amine polymer and polyhydroxy amino ether) layered upon a polyolefin or polyester film substrate, polybutylene terephthalate (PBT), polyimide (PI), polyvinylidene chloride, polyvinyl alcohol, and combinations of these materials.

The crimped portion 234 may be left unfolded to provide a structure for mounting of a door seal 236 for door/cabinet interface sealing (FIG. 11A), or may be folded over and flattened (FIGS. 11B-11D). Metal-to-metal contact may be avoided if an EVOH barrier film or silica glass insert is sandwiched between the flange members 240, 242. The vapor barrier element 244 may be folded over the inner metallic tub terminal flange 240 and may, in turn, be overlain by the folded outer metallic tub terminal flange 242. The outer metallic tub terminal flange 242 may optionally be coupled with the inner metallic tub terminal flange 240 through a metal-to-metal seal 248.

As illustrated in FIG. 11A, the crimped portion 234 may receive a door seal 236, adapted with a crimp seat 292 for retention on the crimped portion 234. The crimp seat 292 may have an inner configuration complementary with the crimped portion 234 configuration to enable an interference fit. Optionally, an adhesive can be included to lock the crimped portion 234 to the crimp seat 292. The inner metallic tub end plate 230 may be offset somewhat from the outer metallic tub end plate 232 to define a crimped flange recess 246. This may enable the crimped portion 234 to be folded into the crimped flange recess 246 along the inner metallic tub end plate 230, as illustrated in FIG. 11D.

As discussed above, high-velocity metal forming may move metal at a speed such that the metal plastically flows. For most metals, speeds greater than about 100 meters/second (m/s) may result in plastic flowing of the metal. These speeds may be about at least 100 times faster than traditional stamping/press break methods, which are about 1 m/s. Energy for forming the metal at high velocity may be generated by a high-voltage instantaneous controlled release of electric current from a bank of capacitors to create a high-intensity electromagnetic force field. Electromagnetic energy may be utilized to reshape portions of a metallic workpiece without the need for molds, dies, anvils, and the like. A high-intensity electromagnetic force field may be generated, and the metallic workpiece may be selectively introduced into the force field, which may bend or fold the workpiece in a preselected manner to shape the workpiece into a finished product. The effect of the force field may be to selectively move portions of the terminal flanges 240, 242 at a high velocity due to plastic flow in the terminal flanges 240, 242.

Alternatively, high-pressure waves may be directed toward selected areas of a workpiece to impact the selected areas and bend the workpiece, or drive the workpiece into a mold or around a die. High-pressure waves may be generated by a high-voltage instantaneous controlled release of electric current from a bank of capacitors to trigger a controlled explosion in a suitable chamber adapted for directing the pressure waves against the workpiece.

A pulse metal forming apparatus may comprise a housing having a suitable strength, durability, and configuration for the purposes intended. A pulse metal forming apparatus suitable for fabricating flanges may have a configuration adapted to enable flanges to pass through the housing during the generation of high-pressure waves. A pair of elongate electrodes may extend into the housing in spaced collinear disposition. A sacrificial foil or other suitable incendiary material may be coupled between the electrodes for instantaneous ignition.

High-pressure waves may be generated by a pulse metal forming apparatus comprising a housing having a suitable strength, durability, and configuration for the purposes intended. A pulse metal forming apparatus suitable for fabricating flanges may have a configuration adapted to enable flanges to pass through the housing during the generation of high-pressure waves. A pair of elongate electrodes may extend into the housing in spaced collinear disposition. A sacrificial foil or other suitable incendiary material may be coupled between the electrodes for instantaneous ignition.

The electrodes may be located a selected distance away from flanges to be fabricated. Introduction of a high-voltage instantaneous release of electric current across the electrodes from a bank of capacitors may explosively combust the foil, thereby generating pulse pressure waves away from the electrodes and against one or more flanges. The intensity of the pulse pressure waves may introduce plastic flow in such flanges, and may urge such flanges against a die or anvil to produce a selected final flange profile. Additional pulse pressure waves may be generated to fully form such flanges.

Referring again to FIGS. 11B-11D, with the vapor barrier element 244 folded over the inner metallic tub terminal flange 240 (FIG. 11B), electromagnetic energy may be directed toward the outer metallic tub terminal flange 242 to fold the terminal flange 242 over the vapor barrier element 244 and terminal flange 240 (FIG. 11C). It may be necessary to shield portions of the terminal flange 240 to enable the terminal flange 240 to remain in its initial configuration. Shielding may consist of not applying an electromagnetic field to a metal flange or other metal structure at a selected location, or introducing a solid fixture or block against a selected portion of the flange to prevent movement relative to adjacent unshielded portions. When fabricating a hermetic seal, the flange may be folded or crimped without interruptions so as to produce a continuous seam.

A second application of electromagnetic energy may be directed toward the terminal flanges 240, 242 to fold the crimped portion into the flange recess 246. This may hermetically seal the interstitial space 226. An additional application of energy may seal the flange 242 to the flange 40 with the metal-to-metal seal 248 to ensure that the interstitial space 226 is hermetically sealed.

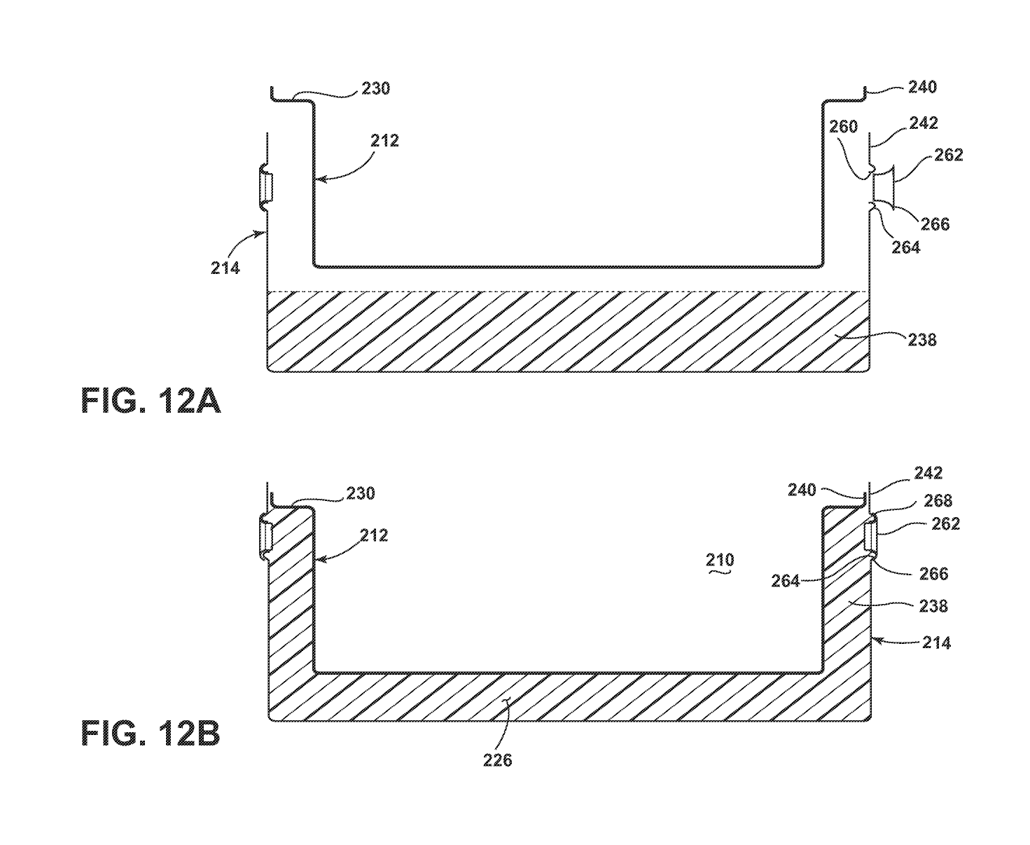

At an appropriate step in the manufacturing process, e.g. during or after hermetic sealing, the interstitial space 226 may be evacuated, thereby providing, with the thermal insulating material 238, a vacuum insulation layer between the inner metallic tub 212 and outer metallic tub 214. For example, referring to FIG. 12A, the outer tub 214 may be filled with a selected quantity of a loose insulating material 238 such as fumed silica. The inner tub 212 may then be positioned and pressed into the outer tub 214, and vibrated until the inner and outer tub terminal flanges 240, 242 are suitably aligned for the crimping process (FIG. 12B). The quantity of insulating material 238 may be selected so that it may fill the interstitial space 228 when the flanges 240, 242 are suitably aligned.

The vapor barrier element (not shown) may be introduced between the flanges 240, 242, the crimp (not shown) may be made, and a vacuum may then be pulled on the interstitial space 228. As an example, evacuating the interstitial space 226 may be accomplished through one or more interstitial openings 260 in one or both tubs 212, 214 that may be subsequently sealed with one or more interstitial opening plugs 262. The interstitial openings 260 may include a rounded annular shoulder 264, and the opening plugs 262 may include a circumferential flange 266. After the plug 262 is seated in the opening 260, the circumferential flange 266 may be electromagnetically crimped with the annular shoulder 264 to produce a crimped hermetic seal 268 in general accordance with the methods described herein. Alternatively, the opening 260 may be welded closed or the plug 262 may be welded to the opening 260. Furthermore, filler material 238, such as a powder or a reacting foam, may be blown or drawn through the interstitial openings 260 into the interstitial space 226 after crimping of the terminal flanges 240, 242 is complete, either to fill an empty interstitial space 226 or add insulating material 238 to correct a volume deficiency,

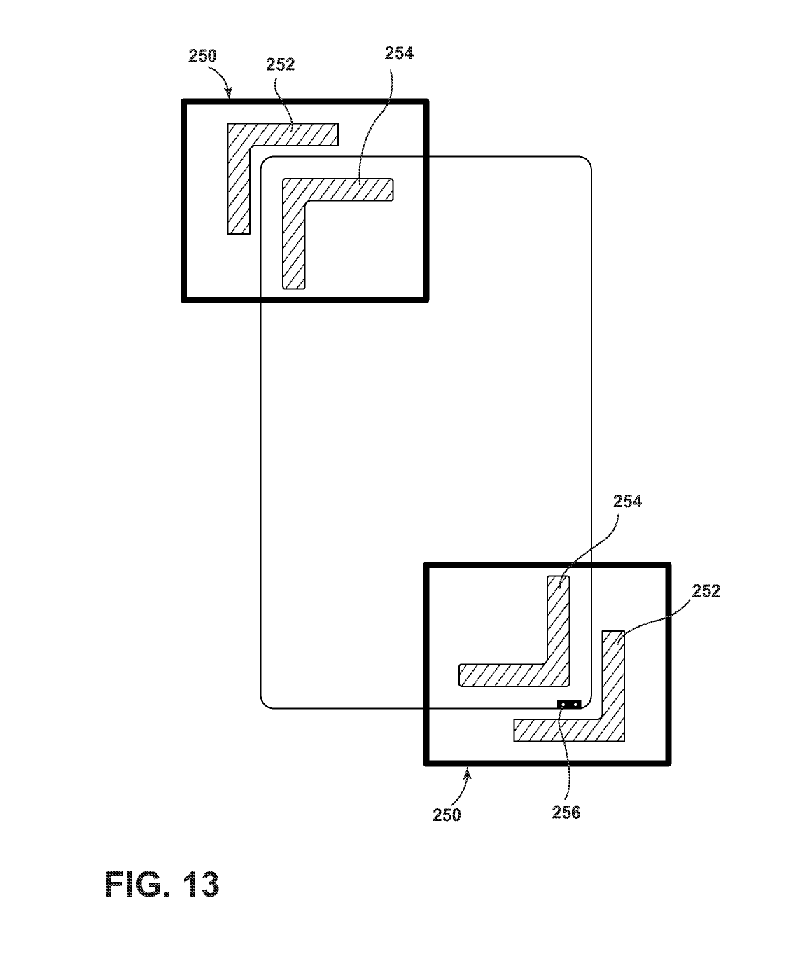

Referring now to FIG. 13, a corner tooling assembly 250 may comprise a corner die 252 and a corner driver 254 to shape and/or sharpen the corners of the tubs using HVMF. The hermetic seal may be fabricated by the high-intensity electromagnetic force field method, with the corner finishing performed by the high-pressure pulse wave method. For example, the corner tooling assembly 250 may form a reduced radius right angle at the sidewall-to-end wall transition. The corner driver 254 may be configured to generate high-intensity force fields to urge the metallic tub corners into the corner die 252, which may have a much sharper corner than is obtainable with traditional stamping/drawing processes. Alternatively, the corner driver 254 may be driven against the corner die 252 with high-pressure pulse waves. Either operation may be conducted on the tubs 212, 214 after draw-forming but prior to crimping of the terminal flanges 240, 242.

The plasticity of the metal may also enable a coupling fixture 256, such as a bracket, hinge plate, and the like, to be embossed into a metallic tub 212, 214, thereby eliminating a separate manufacturing step. Similarly, fixtures such as drawer glides, motor brackets, compressor brackets, and the like, may be embossed into a metallic tub 212, 214 prior to crimping, utilizing the herein described methods so that the hermetic seal of the interstitial space 226 may be maintained, keeping the interstitial vacuum intact.

Referring now to FIG. 14, a high-velocity metal forming generator 258 may be configured for travel (A) along an outer perimeter of the outer metallic tub 214, spaced a suitable distance from the outer metallic tub 214 so that a face of the generator 258 travels along a coil face travel path 290. Alternatively, the generator 258 may travel along an inner perimeter of the inner metallic tub 212. The generator 258 may fold the flanges 240, 242 as the generator 258 continuously travels along the flanges 240, 242. Alternatively, the generator 258 may fold the flanges 240, 242 during a sequence of start-stop movements.

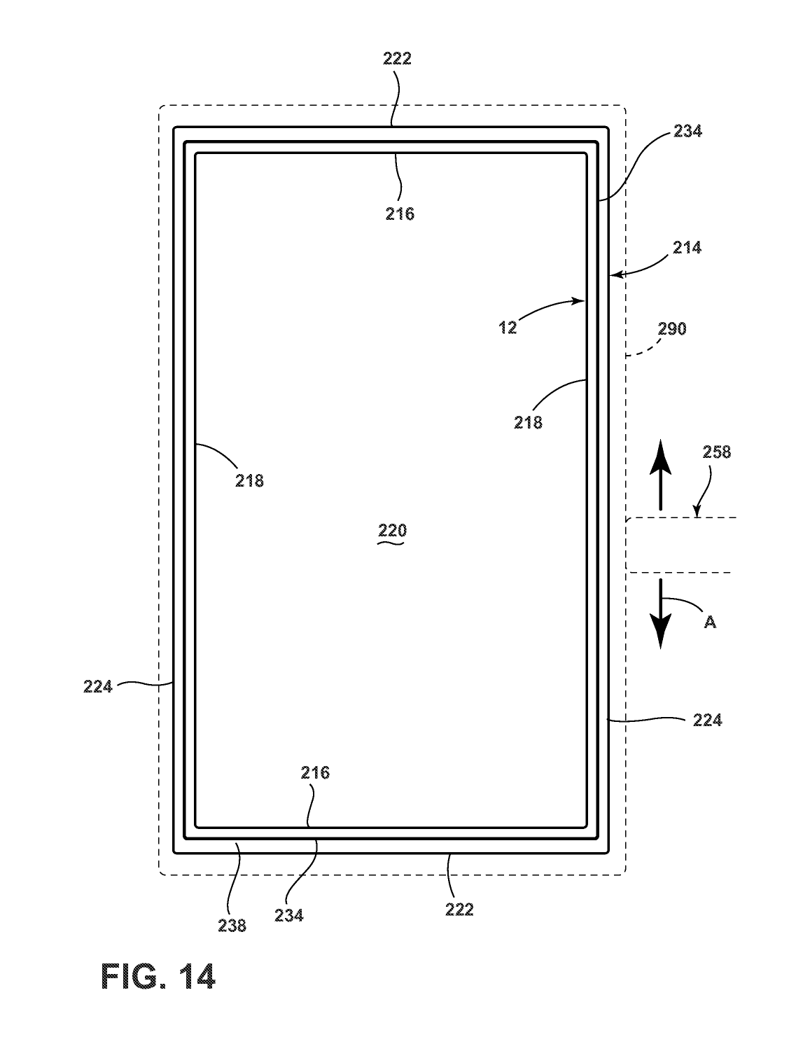

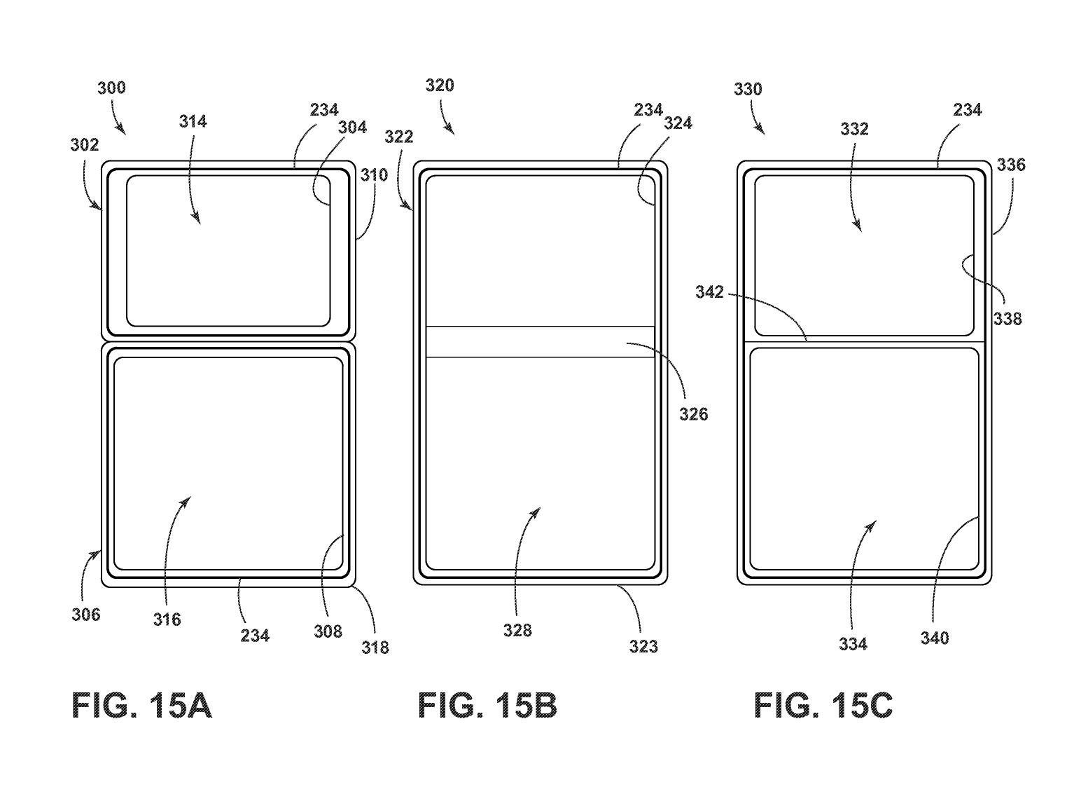

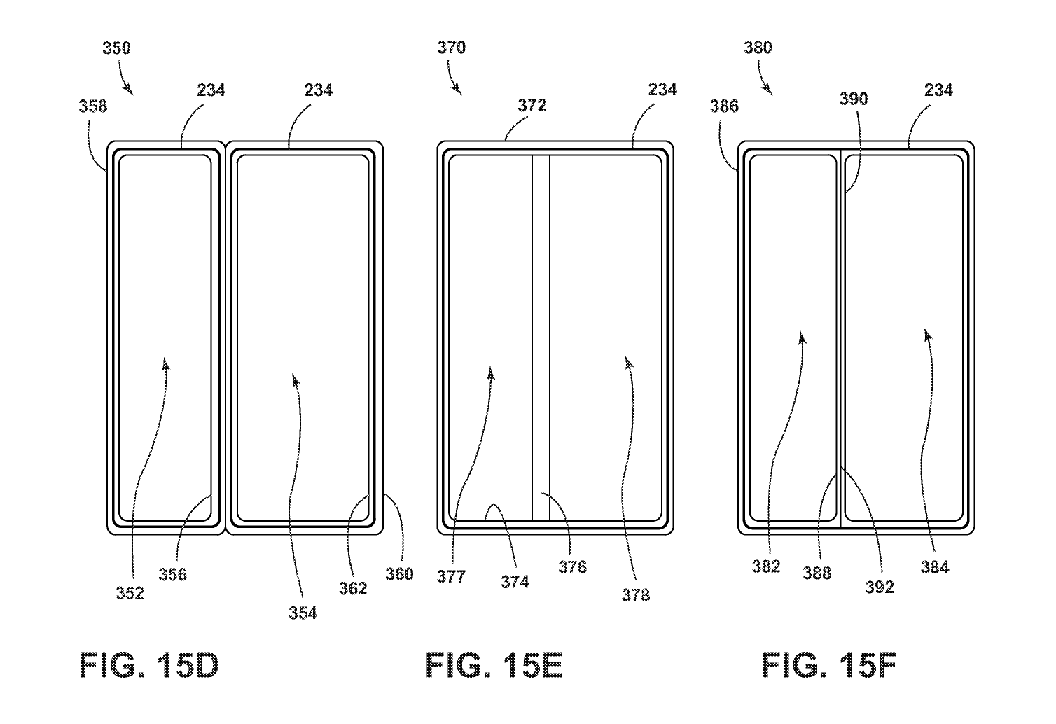

FIGS. 15A-15F illustrate different fabrication techniques for a cabinet providing both refrigerator and freezer chambers. In FIG. 15A, a first embodiment of a refrigerator cabinet shell 300 includes a freezer cabinet 302 and a refrigerator cabinet 306. The freezer cabinet 302 has an inner metallic tub 304 defining a freezer chamber 314 and an outer metallic tub 310 that are coupled as previously described by a crimped portion 234. The refrigerator cabinet 306 has an inner metallic tub 308 defining a refrigerator chamber 316 and an outer metallic tub 318 also coupled by a crimped portion 234. The cabinets 302, 306 may be coupled together in a suitable manner, such as by adhesives, welding, fasteners, and the like.

FIG. 15B illustrates an embodiment 320 that may comprise a single cabinet 322 defining a chamber 328 having an outer metallic tub 323 and an inner metallic tub 324 coupled through a crimped portion 234. The cabinet 322 may be separated into a freezer section and a refrigerator section through an interior insulated wall 326.

FIG. 15C illustrates an embodiment 330 of a cabinet that may have a single outer metallic tub 336 enclosing a freezer cabinet 332 and a refrigerator cabinet 334. The refrigerator cabinet may include an inner metallic tub 340. The freezer cabinet may include an inner metallic tub 338. The inner metallic freezer tub 338 may be coupled with the outer metallic tub 336 through a first portion of the crimped portion 234. Similarly, the inner metallic refrigerator tub 340 may be coupled with the outer metallic tub 336 through a second portion of the crimped portion 234. Finally, the inner metallic freezer tub 338 may be coupled with the inner metallic refrigerator tub 340 through a crimped portion 342.

FIG. 15D is similar to FIG. 15A in that a single refrigerator cabinet shell 350 may include a vertically disposed freezer cabinet 352 and a vertically disposed refrigerator cabinet 354. The freezer cabinet 352 may include an outer metallic tub 358 and an inner metallic tub 356. The refrigerator cabinet 354 may have an outer metallic tub 360 and an inner metallic tub 362. A crimped portion 234 may be used to couple the inner metallic tubs 356, 360 to the outer metallic tubs 358, 362. The freezer cabinet 352 may be coupled with the refrigerator cabinet 354 in a suitable manner, such as with fasteners, adhesives, welding, and the like.

FIG. 15E is similar to FIG. 15B, in that a single refrigerator cabinet shell 370 may include an outer metallic tub 372 and an inner metallic tub 374 divided into a freezer section 377 and a refrigerator section 378 by an interior insulated wall 376.

FIG. 15F is similar to FIG. 15C in that a refrigerator cabinet shell 380 may comprise a single outer metallic tub 386, and a pair of inner metallic tubs 388, 390 defining a freezer chamber 382 and a refrigerator chamber 384, respectively. The inner metallic tubs 388, 390 may be coupled with the outer metallic tub 386 through the crimped portion 234. The inner metallic tubs 388, 390 may also be coupled together through a crimped portion 392.

The crimped portions 234, 342, 392 may be hermetically sealed as described previously herein. It may be understood that different generator and tub set-ups may be employed to fabricate the crimped portions 234, 342, 392, which may be fabricated sequentially or concurrently.

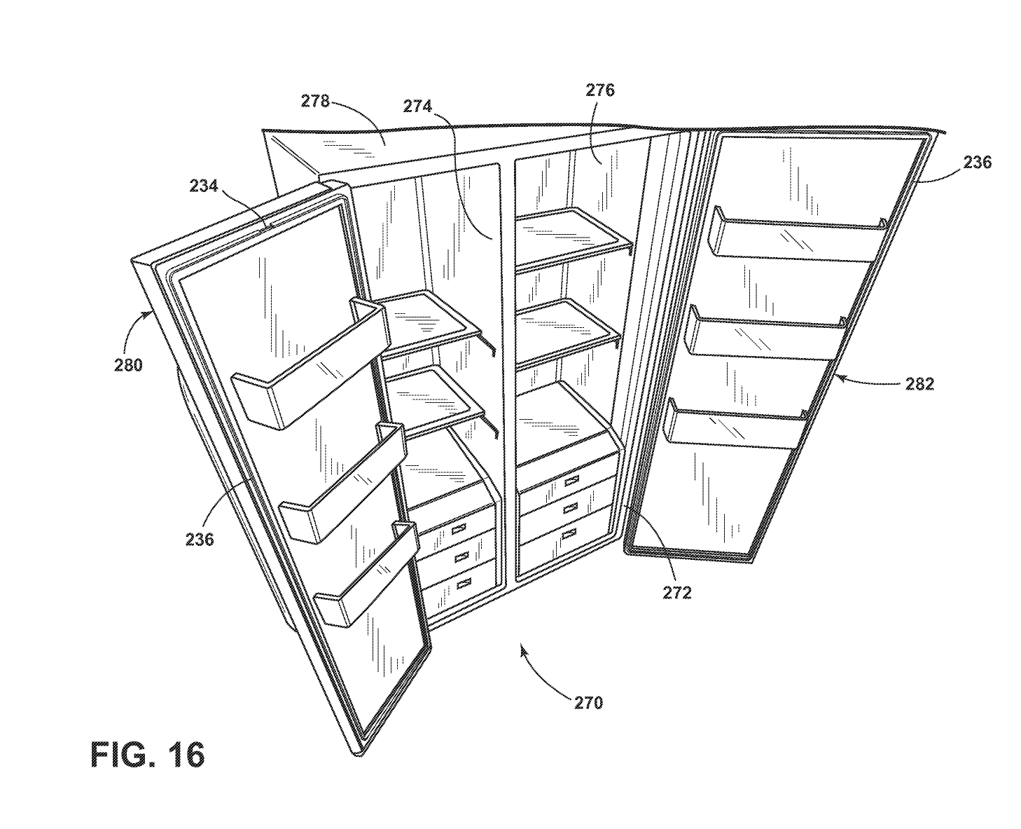

FIG. 16 illustrates a refrigerator/freezer 270, including a cabinet 272 similar to that illustrated in FIG. 15F, that may be furnished with shelving, storage bins, and the like. The cabinet 272 may include an outer metallic tub 278 enclosing and coupled with a freezer inner metallic tub 274 and a refrigerator inner metallic tub 276. The outer metallic tub 278 may be coupled with the freezer inner metallic tub 274 and the refrigerator inner metallic tub 276 as previously described herein. A freezer door 280 may be coupled with a first portion of the cabinet 272 for closing the freezer inner metallic tub 274. A refrigerator door 282 may be coupled with a second portion of the cabinet 272 for closing the refrigerator inner metallic tub 276. The doors 280, 282 may be fabricated as previously described herein with a crimped portion 234, which may be overlaid with a door seal 236, generally as illustrated in FIG. 11A.

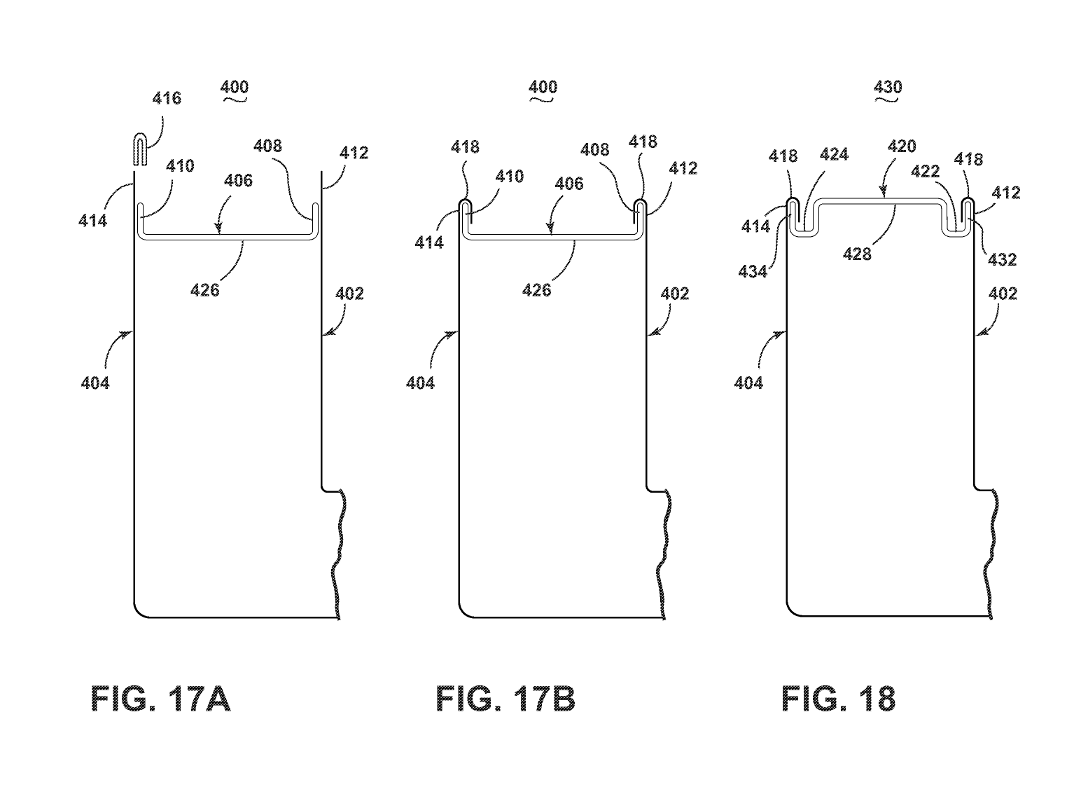

Referring now to FIGS. 17A and 17B, an exemplary embodiment of a cabinet shell 400 is illustrated comprising an inner metallic tub or liner 402 and an outer metallic tub or liner 404. The inner and outer metallic tubs 402, 404 can generally be as previously described herein, which will not be repeated except as necessary to complete understanding of the invention. An interstitial frame 406 can couple the inner tub 402 to the outer tub 404, bridging the interstitial space 226 when the inner tub 402 is nested with the outer tub 404, and forming a hermetic seal 418 (also referred to as a crimped portion). The interstitial frame 406 can have a generally C-channel cross-section.

The interstitial frame 406 can be a generally closed rectangular loop having a frame cross-member 426 dimensioned to bridge the interstitial space 226. The inner edge and the outer edge of the loop can terminate in an interstitial frame inner flange 408 and an interstitial frame outer flange 410, respectively, each extending orthogonally from opposed edges of the cross-member 426. The interstitial frame 406 can be configured so that when the inner metallic tub 402 and outer metallic tub 404 are suitably aligned, the interstitial frame 406 can bridge the interstitial space 226 with the interstitial frame inner flange 408 in contact with the inner metallic tub terminal flange 412, and the interstitial frame outer flange 410 in contact with the outer metallic tub terminal flange 414.

A wall of the outer metallic tub 404 can terminate coplanarly in an outer metallic tub terminal flange 414. A wall of the inner tub 402 can terminate coplanarly in an inner tub terminal flange 412. The outer metallic tub terminal flange 414 can be aligned in contact with the interstitial frame outer flange 410, and the inner tub terminal flange 412 can be aligned in contact with the interstitial frame inner flange 408. The interstitial frame flanges 408, 410 can accept a vapor barrier element 416 generally as illustrated in FIG. 11A-C.

As illustrated in FIG. 17B, the outer metallic tub terminal flange 414 can be folded over the interstitial frame outer flange 410 and the vapor barrier element 416, and the inner metallic tub terminal flange 412 can be folded over the interstitial frame inner flange 408 and the vapor barrier element 416, each in a manner as previously described herein, to form a crimped portion 418.

The interstitial frame 406 can be fabricated of a material having a suitable strength, resiliency, and durability for the purposes intended. The interstitial frame 406 can be fabricated of metal, molded plastic such as a urethane or phenolic, and the like. If the interstitial frame 406 is a plastic, a sealing film/vapor barrier element 416 may be unnecessary because the plastic may thermally isolate the inner metallic tub 402 from the outer metallic tub 404 similar to a vapor barrier element 416.

FIG. 18 illustrates an alternate interstitial arched frame 420. The interstitial arched frame 420 has an arched cross-member 428 separated from an arched frame inner flange 432 and an arched frame outer flange 434 by an inner recess 422 and an outer recess 424, respectively. The arched cross-member 428 can be configured to extend approximately to the height of the crimped portions 418.

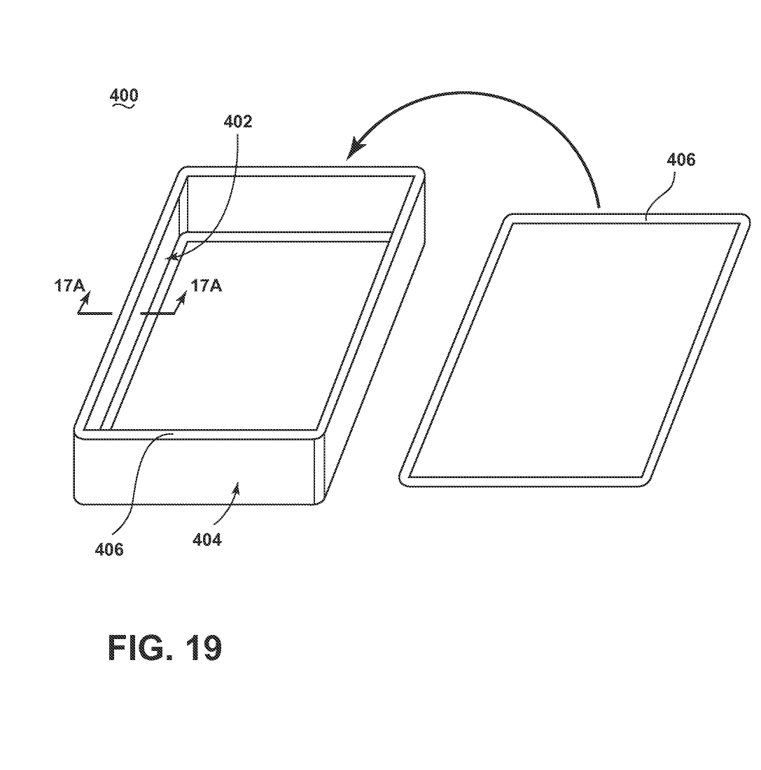

Referring to FIG. 19, the interstitial frame 406, 420 can be fabricated in a single rectangular piece that can be moved over the interstitial space 226, and then lowered into place between the inner metallic tub 402 and outer metallic tub 404. While the frame is suspended in place, the terminal flanges 412, 414 can be folded with or without a vapor barrier element 416 to form the crimped portion 418.

Alternatively, the crimped portion 418 can be fabricated using a roll-forming operation to form a continuous joint between a pair of flanges, e.g. between the interstitial frame inner flange 408 and the inner metallic tub terminal flange 412. The inner liner 402 can alternatively be a plastic tub with the vapor barrier element 416 already attached to the inner tub terminal flange 412. With a plastic inner liner 402, an interstitial frame may be unnecessary, and a process similar to the previously-described process (FIGS. 11A-C) can be utilized.

While the invention has been specifically described in connection with certain specific embodiments thereof, it may be to be understood that this may be by way of illustration and not of limitation. Reasonable variation and modification are possible within the scope of the forgoing disclosure and drawings without departing from the spirit of the invention which may be defined in the appended claims.

What may be claimed may be:

1. A method of encapsulating at least a projection having first and second non-coplanar surfaces of a non-metallic article with a metallic article, the method comprising:
arranging the non-metallic article and the metallic article to locate the projection within a corresponding recess on the metallic article; and
encapsulating the metallic article onto the projection by applying at least one of a pressure wave and an electromagnetic field to form the metallic article about the projection such that the metallic article extends between the first and second non-coplanar surfaces and overlies each of the first and second non-coplanar surfaces.

2. The method of claim 1 wherein the arranging comprises locating the metallic article over the first and second surfaces.

3. The method of claim 1 wherein the arranging comprises locating a portion of a peripheral edge of the non-metallic article, which defines the projection, within the recess.

4. The method of claim 3 wherein the non-metallic article comprises a planar structure with the first and second surfaces being connected by the peripheral edge, and the locating comprising the metallic article overlying the first and second surfaces.

5. The method of claim 1 wherein the encapsulating comprises abutting at least a portion of the metallic article with at least a portion of one of the first and second surfaces.

6. The method of claim 5 wherein the encapsulating comprises abutting at least a portion of the metallic article with both of the first and second surfaces.

7. The method of claim 6 wherein the encapsulating comprises abutting a portion of the metallic article against the projection from the first to the second surfaces.

8. The method of claim 1 further comprising providing a buffer element between the non-metallic article and the metallic article, and the encapsulating comprises encapsulating at least a portion of the buffer element.

9. The method of claim 8 wherein the encapsulating comprises encapsulating both a portion of the buffer element and the non-metallic article.

10. The method of claim 8 wherein the encapsulating secures the buffer element to the non-metallic article.

11. A method of encapsulating at least a projection having first and second opposing surfaces of a non-metallic article with a metallic article, the method comprising:
arranging the non-metallic article and the metallic article to locate the projection within a corresponding recess on the metallic article; and
moving portions of the metallic article at a speed great enough where the portions flow plastically about the projection to encapsulate at least a portion of the projection.

12. The method of claim 11 wherein the arranging comprises locating the metallic article over the first and second surfaces.

13. The method of claim 11 wherein the arranging comprises locating a portion of a peripheral edge of the non-metallic article, which defines the projection, within the recess.

14. The method of claim 13 wherein the non-metallic article comprises a planar structure with the first and second surfaces being connected by the peripheral edge, and the locating comprises the metallic article overlying the first and second surfaces.

15. The method of claim 11 wherein the moving comprises flowing at least a portion of the metallic article onto at least a portion of one of the first and second surfaces.

16. The method of claim 15 wherein the moving comprises flowing at least a portion of the metallic article onto both of the first and second surfaces.

17. The method of claim 16 wherein the moving comprises flowing a portion of the metallic article onto the projection from the first to the second surfaces.

18. The method of claim 11 further comprising providing a buffer element between the non-metallic article and the metallic article, and the moving comprises flowing at least a portion of the non-metallic article onto the buffer element.

19. The method of claim 18 wherein the moving comprises flowing at least a portion of the metallic article to encapsulate both a portion of the buffer element and the non-metallic article.

20. The method of claim 18 wherein the encapsulating secures the buffer element to the non-metallic article.
